(19) United States
(12) Patent Application Publication
(10) Pub. No.: US 2023/0135550 A1
(43) Pub. Date: May 4, 2023

(54) METHODS AND DEVICES FOR DETERMINING A PRODUCT QUALITY

(71) Applicant: Siemens Aktiengesellschaft, München (DE)

(72) Inventors: Daniel Klein, Kastl (DE); Henning Ochsenfeld, Nürnberg (DE); Tobias Seutter, Nürnberg (DE)

(21) Appl. No.: 17/766,767

(22) PCT Filed: Sep. 2, 2020
(86) PCT No.: PCT/EP2020/074446

§ 371 Date: Apr. 6, 2022

(30) Foreign Application Priority Data
Oct. 8, 2019 (EP) 19201906.5

(51) Int. Cl. G05B 19/418

(52) U.S. Cl. CPC G05B 19/41875; G05B 19/41885; G05B 2219/31359

(57) ABSTRACT

Devices and methods for determining a product quality resulting from a manufacturing process are disclosed herein. In one example, the method includes simulatively determining one of a plurality of manufacturing state variables depending on a scattering of the manufacturing state variables, acquiring one of the manufacturing state variables by a sensor, and associatively determining the product quality depending on the manufacturing state variables.

The present patent document is a continuation of PCT Application Serial No. PCT/EP2020/074446, filed Sep. 2, 2020, designating the United States, which is hereby incorporated by reference, and this patent document also claims the benefit of European Patent Application No. 19201906.5, filed Oct. 8, 2019, which is also hereby incorporated by reference.

### TECHNICAL FIELD

The present disclosure relates to methods and apparatuses for determining a product quality that results from a manufacturing method.

### BACKGROUND

Industrial manufacturing methods may include a multiplicity of individual manufacturing acts. In this case, quality assurance measures are required during the course of the manufacturing method in order to provide that the finished product meets the requirements and may be used in a defect-free manner. The manufacturing quality with which products or individual components and groups are manufactured is nowadays already at a very high level, with rates of up to 99% first pass yield (FPY) already being achieved. This means that 99% of the finished products are defect-free.

These quality assurance measures are costly and time-consuming because, among other things, personnel are required, and test and inspection procedures have to be (further) developed and operated. Saving these work acts, which in themselves do not increase further, would open up enormous financial potentials.

For this reason, solutions have already been developed that reduce the scope, complexity and time required for such quality assurance measures and ultimately lead to a significant increase in efficiency in manufacturing.

A very promising approach is the so-called “closed-loop analytics” (CLA) approach. On the basis of algorithms that may be assigned to machine learning, a self-contained analysis chain is generated in order to be able to make reliable statements regarding the quality of the component without the need for direct quality check of the product.

The starting point is a data set, for example, regarding manufacturing state variables such as temperature, pressure, or similar, as well as target variables that are assigned to this input data, such as the distortion of a component at one or multiple sites, which allows a statement to be made regarding the quality of the component.

Based on this data set, it is possible to create predictive models that render it possible to make a prediction regarding the component quality based purely on the input data, wherein for example algorithms and methods from the field of machine learning, are used.

However, it is precisely this data set that may present the users of CLA approaches with the following challenges, which have not yet been adequately resolved.

1. Sufficient amount of data: there may be no data or only insufficient data available that allows a meaningful predictive model to be generated. This may be due, for example, to the fact that not enough data is measured or that the plant is starting up for the first time and there was therefore not yet any possibility of taking measurements. However, it is almost impossible to create a meaningful predictive model without sufficient data.

2. Quality of the data: In order to create a meaningful model, it is not only imperative to have a sufficient amount of data, but the quality of the data is also high. A so-called “noise” in the data set, in other words the correlation between the input data (for example, temperature, pressure) and the output data (for example, distortion of a sheet metal at a certain site) may not be clear, may be reflected in a qualitatively poor model. In addition, problems may arise with the predictive model, especially with manufacturing methods that already offer a very high-quality standard. Such a model also reliably identifies so-called “outliers” or manufacturing deviations that lead to quality problems. However, these may be an exception in the data set and are only insufficiently recorded by a predictive model. This may become a problem, especially when reusable prediction models are to be developed for customers with the same or similar manufacturing methods, because different users may have different parameter constellations.

3. Non-measurable variables: Also, not all manufacturing state variables that have a significant influence on component quality are measurable. This may be, for example, the mechanical stress in a deep-drawn component during the pressing process in the tool or however the temperature in the middle of a cast component. In both cases, a measurement would be almost impossible or at least very difficult, but the quality of a component may be predicted very well with knowledge of these variables.

4. Duration of the learning phase: Especially when hardly any data is available beforehand for a production line or when the production line is being built from scratch, it may take a very long time (up to several months) before a sufficient data set is available to generate a reliable predictive model. In addition, there may be changes in the structure of a productive plant, which in turn makes it necessary to create a new data record.

Previous approaches to determining product quality may be roughly divided into the following areas.

1. Data-based quality check: As described in the introduction, it is possible to carry out a so-called data-based quality check based on manufacturing data and a predictive model. The predictive model may be generated using different processes and methods, most of which may be assigned to so-called machine learning. However, the respective predictive model is only available after the associated learning phase.

2. Direct quality check: It is possible to use special machines and facilities that render possible a quality check. For example, soldering sites may be checked using X-rays or after a deep-drawing process distortion may be measured using images or laser measurements. Such facilities come in many different forms with the common disadvantage that they are very expensive and may slow down production.

3. Process simulation: There are many different possibilities to simulate manufacturing methods and to examine the main influences digitally. Such process simulations are common in many manufacturing areas, such as forming, and are used intensively in process development. These simulation technologies are already so advanced that certain processes may be simulated with a very high level of accuracy (in part < 5% deviation). This makes it possible to develop and optimize computer-implemented methods and to consider all relevant aspects that have an influence. However, this degree of accuracy requires very precisely modeled and therefore very complex simulation models that cannot be calculated anywhere near in real time.

### SUMMARY

The object to be achieved is therefore to provide effective quality assurance measures as early as the start-up of manufacturing methods.

The scope of the present disclosure is defined solely by the appended claims and is not affected to any degree by the statements within this summary. The present embodiments may obviate one or more of the drawbacks or limitations in the related art.

A method for determining a product quality that results from a manufacturing method includes: a simulative determination of one of multiple manufacturing state variables as a function of a scattering manufacturing state variable of the manufacturing state variables; a sensory detection of one of the manufacturing state variables; and an associative determination of the product quality as a function of the manufacturing state variables.

The simulative determination may include performing a system simulation of the manufacturing method.

Moreover, the method may include a simulative detection of a manufacturing state variable that cannot be detected in a sensory manner of the manufacturing state variables as a function of the manufacturing state variable(s) detected in a sensory manner of the manufacturing state variables.

The simulative detection may include executing an instance of the system simulation, the instance being simplified in terms of computational complexity, and/or an analytical equation.

The system simulation may be parameterized as a function of the scattering manufacturing state variable of the manufacturing state variables.

The system simulation may include a continuous simulation, a one-dimensional simulation, and/or an analytical equation.

The continuous simulation may include a finite element method, a computational fluid dynamics method and/or a multi-body simulation.

The simulative determination may include sampling a value range of the scattering manufacturing state variables of the manufacturing state variables.

Sampling may include performing a statistical experimental design method.

The statistical experimental design method may include Monte Carlo sampling and/or Latin Hypercube sampling.

Associative determination may include performing a machine learning method.

The machine learning method may include a decision tree and/or an artificial neural network.

The method may further include separating the product in dependence upon its determined product quality.

An apparatus for determining a product quality that results from a manufacturing method includes: a simulation facility for the simulative determination of one of multiple manufacturing state variables as a function of a scattering manufacturing state variable of the manufacturing state variables; a detection facility for the sensory detection of one of the manufacturing state variables; and a determination facility for associative determination of the product quality as a function of the manufacturing state variables.

Moreover, the apparatus may be configured so as to perform the method according to exemplary embodiments.

Moreover, the apparatus may include a simulative detection facility for simulative detection of one manufacturing state variable that cannot be detected in a sensory manner of the manufacturing state variables as a function of the manufacturing state variable(s) detected in a sensory manner of the manufacturing state variables.

The apparatus may moreover include a separation facility for separating the product in dependence upon its determined product quality.

### BRIEF DESCRIPTION OF THE FIGURES

The disclosure is explained in short below with the aid of exemplary embodiments and with reference to the drawings, wherein identical reference characters identify identical or similar elements.

FIG. 1 schematically depicts a predictive, quality-assuring “closed-loop analytics” (CLA) approach in accordance with an example from the prior art.

FIG. 2 schematically depicts a method for determining a product quality that results from a manufacturing method in accordance with exemplary embodiments.

FIG. 3 schematically depicts a sampling of a value range of scattering manufacturing state variables of the manufacturing state variables in accordance with an exemplary embodiment.

FIG. 4 schematically depicts an apparatus for determining a product quality that results from a manufacturing method in accordance with exemplary embodiments.

### DETAILED DESCRIPTION OF EXEMPLARY EMBODIMENTS

The disclosure is further explained below with the aid of embodiments and with reference to the drawings.

A description of exemplary embodiments in specific fields of application does not imply any restriction to these fields of application.

Elements of schematic representations are not necessarily drawn to scale, but rather so that their function and purpose may be understood by those skilled in the art.

Unless expressly stated otherwise, the features of the various embodiments may be combined with one another.

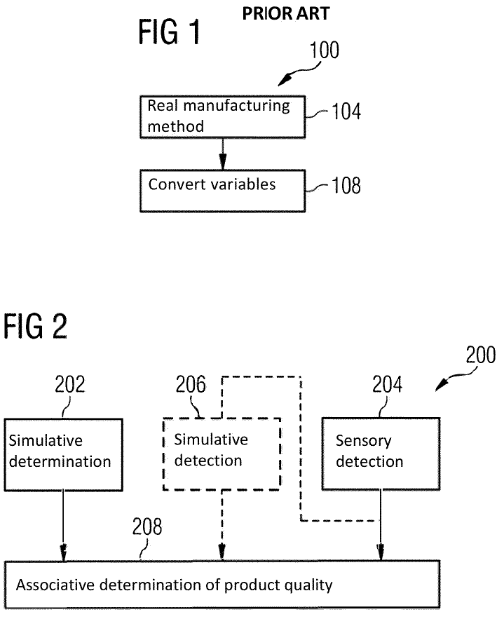

FIG. 1 schematically illustrates a predictive, quality-assuring “closed-loop analytics” approach 100 in accordance with an example from the prior art.

FIG. 1 illustrates a real manufacturing method 104 for a product. Manufacturing state variables X_{SEN} ∈ X that may be detected in a sensory manner, such as temperature, pressure, or similar, may be derived from this manufacturing method 104. The manufacturing state variables X are converted into a central performance indicator (“key performance indicator”, KPI) on the basis of a predictive model 108, which enables a statement to be made regarding the quality of the manufactured product. In particular, this may be a product quality Q.

The expression “manufacturing methods” may be understood to mean methods for producing a product, such as a component or an assembly.

The term “product” may be understood to mean a product to be manufactured before the end of the manufacturing method, and the manufactured product after the end of the manufacturing method.

The expression “manufacturing state variables” may be understood in particular to mean such physical state variables that may be set on or in the product that is to be manufactured during the course of the real manufacturing method 104 or may be set in the manufacturing machine. Examples include temperature, pressure, pressing force, sheet metal position, or similar.

The term “predictive” may be understood to mean that a prediction is made.

The expression “a predictive model” may be understood to mean a model that renders it possible to make a prediction.

The expression “closed-loop analytics” may be understood to mean that a predictive model 108 is provided that may make reliable statements regarding a quality Q of the manufactured component on the basis of manufacturing state variables X without a direct quality check of the component being necessary, and (not shown in FIG. 1) without this quality Q being reported back to the real manufacturing method 104.

The starting point in this case is a data set, for example, regarding manufacturing state variables such as temperature, pressure, or similar, as well as target variables that are assigned to this input data, among the manufacturing state variables X such as the distortion of a component at one or multiple sites, which allows a statement to be made regarding the quality Q of the component.

Based on this data set, it is possible to create predictive models 108 that render it possible to make a prediction regarding the component quality Q of the component based purely on the input data, wherein for example algorithms and methods from the field of machine learning are used.

However, it is precisely this data set that may present the users of CLA approaches with the already mentioned challenges, which have not yet been adequately resolved.

FIG. 2 schematically illustrates a method 200 for determining a product quality Q that results from a manufacturing method 104 in accordance with exemplary embodiments of the disclosure.

The method 200 is designed in several acts.

In act 202, a simulative determination 202 of one of multiple manufacturing state variables X_{SIM} ∈ X is performed as a function of a scattering manufacturing state variable of the manufacturing state variables X.

The multiple manufacturing state variables X may include temperature, pressure, pressing force, sheet metal position, or similar, possibly at different positions. These form input variables for the associative determination 208 that is further explained below.

The scattering manufacturing state variables of the manufacturing state variables X may be in particular in the real manufacturing method 104 scattering input variables, such as pressing force, sheet metal position, or similar. These are decisive for deviations in certain quality parameters. For example, a deviating contact pressure and a slightly deviating temperature may lead to distortion of the product at the end.

The expression “scattering” may be understood in particular to mean deviating from a mean value. A deviation may exist, for example, for different manufacturing methods that take place one after the other or for different manufacturing acts. The deviation may occur as a function of time.

In act 204, a sensory detection 204 of one of the manufacturing state variables X_{SEN} ∈ X takes place.

As already mentioned, manufacturing state variables X_{SEN} ∈ X that may be detected in a sensory manner, such as temperature, pressure, or similar, may be derived from the manufacturing method 104. These are also included in the associative determination 208 as input variables.

The expression “may be detected in a sensory manner” may be understood to mean detectable by sensors and, in particular, detectable by sensors with justifiable effort.

In act 208, an associative determination 208 of the product quality Q takes place as a function of the manufacturing state variables X.

The expression “associative” may be understood to mean in particular producing an association between input and out patterns. In other words, a total of all determined or recorded manufacturing state variables X are connected or linked to a product quality Q of the manufactured product on the basis of a predictive model 108, 408.

The predictive model 108, 408 is intended to derive generalized rules (product quality Q) from exemplary observations (manufacturing condition variables X).

Advantageously, due to its generally applicable approach of supplying all available manufacturing state variables X to the predictive model 108, 408, the method allows fundamentally reusable predictive models 108, 408 to be designed for customers with the same or similar manufacturing methods 104.

The simulative determination 202 may include performing a system simulation of the manufacturing method 104.

The expression a “system simulation” may be understood to mean in particular a complete process simulation of a manufacturing method for a product.

There are different possibilities to simulate the manufacturing method 104 and to examine the main influences digitally. Such process simulations are common in many manufacturing areas, such as forming, and are used intensively in process development.

A simulation is in fact merely an approximation of reality based on various assumptions. This means that the result of a simulation does not correspond exactly to reality and is subject to deviations. For example, if the meshing is too rough, contour elements or curves in the component cannot be adequately taken into account. With a professional application of the simulation methods, however, it is possible to keep the deviations from reality small. It is by no means unusual for a single run of a system simulation to take several hours. It is therefore advisable to carry out the simulative determination 202 in particular before the actual manufacturing method 104. The simulation techniques in question are so advanced that certain manufacturing methods 104 may be simulated with very high accuracy (e.g., partly <5% deviation).

Accordingly, it is possible on the basis of a simulative determination 202 to examine the influences of any manufacturing state variables X on the product quality Q.

This is possible to a far greater extent than in reality, because there are significantly more manufacturing state variables X available that may be evaluated for the entire component. Also, not all manufacturing state variables that have a significant influence on component quality Q are measurable. This may be, for example, the mechanical stress in a deep-drawn component during the pressing process in the tool or however the temperature in the middle of a cast component. In both cases, a measurement would be almost impossible or at least very difficult, but the quality Q of a component may be predicted very well with knowledge of these variables.

This renders it possible to develop and optimize manufacturing methods 104 on the computer and to consider all relevant aspects that have an influence on the product quality Q.

Moreover, a level of detail may be considered that would be impossible on the real component.

In addition, parameter variations may be carried out quickly and in a simple manner on the input variables among the manufacturing state variables X (for example change in the process forces, slight change in geometry, small variation in material properties).

In addition, such parameter changes may be performed automatically with the result that large data sets may be generated extremely quickly.

Especially when hardly any data is available beforehand for a production line or when the production line is being built from scratch, it may take a very long time (up to several months) before sufficient data is available to generate a reliable predictive model. In addition, there may be changes in the structure of a productive plant, which in turn makes it necessary to create a new data record.

Advantageously, the method therefore allows a meaningful predictive model to be generated even in cases in which sufficient data is not measured or the manufacturing method 104 is started up for the first time and therefore there is no possibility for performing a measurement.

Advantageously, the significantly more numerous manufacturing state variables X and the improved level of detail allow, particularly in cases in which the quality of the data is of high quality, to improve a correlation between the input data and the target data and thus to improve the informative value of the predictive model 108, 408. In addition, so-called “outliers” or manufacturing deviations that lead to quality problems are detected more reliably. In particular, reusable predictive models 108, 408 may thus be developed for customers with the same or similar manufacturing methods 104.

The method 200 may moreover have an optional method act.

As indicated by dashed lines in FIG. 2, the method 200 may include a simulative detection 206 of one manufacturing state variable X_{VSEN} that cannot be detected in a sensory manner of the manufacturing state variables X as a function of the manufacturing state variable X_{SEN} that is detected in a sensory manner of the manufacturing state variables X.

The expression “cannot be detected in a sensory manner” may be understood to mean not detectable by sensors and, in particular, not detectable by sensors with justifiable effort.

This act may be performed in particular between the acts of sensory detection 204 and associative determination 208. The sensory detection 204 is required because of the dependency on the manufacturing state variable X_{SEN} that is detected in a sensory manner of the manufacturing state variables X, and the associative determination 208 follows because the simulative detection 206 may add further production variables X_{SEN} that cannot be detected in a sensory manner of the manufacturing state variables X and independence thereon the associative determination 208 of the product quality Q is to take place.

The simulative detection 206 may include executing an instance of the system simulation, the instance being simplified in terms of computational complexity, and/or an analytical equation.

The expression “computational complexity” may be understood to mean an amount of resource effort required to perform an algorithm.

The expression “analytical equation” may be understood to mean a mapping that is present in a mathematically closed form.

A system simulation of the manufacturing method 104 requires a long computing time with sufficient accuracy, with the result that real-time operation may not be possible or may only be possible in very rare exceptions.

In this case, so-called virtual sensors 406 may help (cf. FIG. 4), which only include parts of the system simulation model or simplified system simulation models. Additionally, or alternatively, analytical equations may also be included, which are also based on modeling.

These virtual sensors 406 may then be operated in parallel with the real manufacturing method 104 and render it possible on the basis of the reduced/simplified simulation model to supplement the data set of the manufacturing state variables X as a function of the manufacturing state variables X_{VSEN} _{∈} X that are detected in a sensory manner in the real production method 104 with manufacturing state variables X_{SEN} _{∈} X that cannot be detected in a sensory manner.

Advantageously, this supplementing of the available manufacturing state variables X also allows a correlation between the input data and the target data to be improved and the predictive model 108, 408 to be more informative.

The system simulation may be parameterized as a function of the scattering manufacturing state variable of the manufacturing state variables X.

A parameterization of the system simulation with regard to the scattering manufacturing state variables advantageously causes all input variables (for example, pressing force, sheet metal position, etc.) that scatter in the real manufacturing method 104 to also be variable in the simulation model, with the result that an examination of deviation effects on certain quality parameters is possible. For example, a different contact pressure and a slightly different temperature may lead to distortion of the product at the end. As a result, parameter variations may be carried out quickly and in a simple manner on the input variables among the manufacturing state variables X (for example, change in the process forces, slight change in geometry, small variation in material properties). In addition, such parameter changes may be performed automatically with the result that large data sets with regard to the manufacturing state variables X may be generated extremely quickly.

The system simulation may include a continuous simulation, a one-dimensional simulation, and/or an analytical equation.

The expression “continuous simulation” may be understood to mean simulations, the underlying models of which describe the modeled system by differential equations.

The expression “one-dimensional (1D) simulation” may be understood to mean simulations, the underlying models of which describe the impact of individual influencing variables on the modeled system and are therefore associated with an adapted modeling effort, highly efficient calculations and short computing times. For example, 1D simulations may be provided on the basis of commercial software packets such as Simulink®.

The continuous simulation may include a finite element method, a computational fluid dynamics method, and/or a multi-body simulation.

In dependence upon the respective manufacturing methods, different types of continuous simulation may be used. The most common are finite element methods (FEM), which are typically used in manufacturing methods that involve solids, for example during forming. Computational Fluid Dynamics (CFD) methods are used in flow processes. A multi body simulation (Multi Body Dynamics, MBD) deals with large rigid body motions. Combinations of these methods are also possible. In principle, however, all methods for simulating continuous manufacturing methods have in common that (partial) differential equations are formulated in order to describe the relationship between various physical (manufacturing) state variables.

Associative determination 208 may include performing a machine learning method.

The expression “machine learning” may be understood to mean building experience (learning from examples) and generalizing this experience.

In particular, this experience may be built up in the form of a statistical model which is based on training data (the examples) and recognizes patterns and regularities in this training data.

Advantageously, the build-up of experience means that unknown data (examples) may then also be assessed (generalization) by way of a learning transfer.

The machine learning method may include a decision tree and/or an artificial neural network.

Decision trees are ordered, directed tree structures that are used to represent hierarchically sequential decision rules. Decision trees include a root node, any number of inner nodes that represent logical rules, and at least two leaves that represent an answer to the decision problem. In the context of machine learning, decision trees may be used in particular for automatic classifications.

Artificial neural networks (ANN) are networks of artificial neurons. An ANN has a topology/network structure that defines how many artificial neurons are on how many layers, and which artificial neurons from which successive layers are interconnected. An ANN includes an output layer that provides an initial pattern of the ANN, and may include one or multiple hidden layers (so-called multi-layer networks). As a rule, input patterns are assessed by propagating them through the ANN to the output layer in accordance with the topology. The data between successive layers is weighted specifically for the pair of artificial neurons from the successive layers which are involved in the transmission. In addition to other influencing factors, these weights in particular represent the experience of the ANN. Appropriate learning methods are used to build up this experience, in other words to get the ANN to provide desired output patterns for certain input patterns. The aim of one of the learning methods, supervised/observed learning, is to enable the ANN after a series of examples with different input and output patterns to establish associations between the input and output patterns.

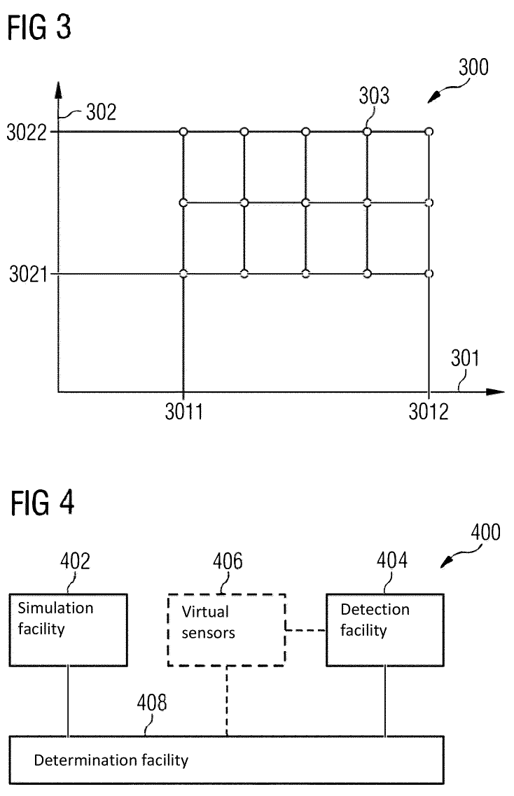

FIG. 3 schematically depicts a sampling 300 of a value range of scattering manufacturing state variables of the manufacturing state variables X in accordance with an exemplary embodiment of the disclosure.

The simulative determination 202 may include sampling 300 the value range of the scattering manufacturing state variables of the manufacturing state variables X.

In the example in FIG. 3, the sampling 300 of the value range of two scattering manufacturing state variables of the manufacturing state variables X takes place, for example, of a horizontally plotted contact pressure 301, the specified value range of which extends from a lower limit 3011 to an upper limit 3012, and a vertically plotted temperature 302, the specified value range of which extends from a lower limit 3021 to an upper limit 3022. The value ranges of the two scattering manufacturing state variables of the manufacturing state variables X together span a parameter space which is to be sampled at certain intervals that are predetermined for the scattering manufacturing state variables of the manufacturing state variables X in each case.

For better understanding, the example in FIG. 3 provides, by way of example, for the sampling 300 of the parameter space to be carried out in accordance with a regular grid which is equidistant in the respective dimension, and which leads to a multiplicity of combinations/tuple 303 of contact pressure 301 and temperature 302. In other words, the parameter space is completely sampled in accordance with a regular grid that extends over the parameter space.

At each tuple 303 of the two scattering manufacturing state variables of the manufacturing state variables X, the simulative determination 202 explained above takes place as a function of the scattering manufacturing state variables of the manufacturing state variables X. Each tuple 303 thus represents a separate simulation run.

Each separate simulation run is then carried out with the result that the output variables X_{SIM} are available among the manufacturing state variables X as a function of the scattering manufacturing state variables of the manufacturing state variables X.

Advantageously, parameter variations may be carried out quickly and in a simple manner (for example, change in process forces, slight change in geometry, small variation in material properties).

Moreover, this largely automatable “model sampling” renders it possible to obtain a large number of data sets in a comparatively short time. Although a single simulation run may take several hours, it is however possible to run the simulation runs in parallel, because the individual simulation runs may not be dependent on one another. The data set of the manufacturing state variables X generated at the end of each simulation run naturally allows conclusions to be drawn regarding the relationship between the manufacturing state variables X and a product quality Q and may therefore be used to build up experience of the predictive model 108, if necessary, even before the manufacturing method has been started up. The previously very long training time for the predictive model 108 is thus at least greatly reduced.

In addition, this virtual data set may of course be easily supplemented with parameter sets that occur very rarely in real life, and quality measures that are not available in real life may possibly also be used to create the prediction model. For example, the voltage or temperature in the middle of a component may be evaluated, which would not be measurable in real terms, but does allow a decisive statement to be made regarding the component quality.

Sampling 300 may include performing a statistical experimental design method.

Alternatives to the regular grid that is illustrated in FIG. 3 result from the statistical experimental design.

The statistical experimental design method may include Monte Carlo sampling and/or Latin Hypercube sampling.

The expression “statistical experimental design” may be understood to mean such statistical methods that are used prior to commencing the experiment in order to determine experiment plans in the sense of certain accuracy specifications.

In particular, with as few experiments as possible (here: simulation runs) an effective connection between the (in particular scattering) input variables and the target variables among the manufacturing state variables X may be recorded with sufficient accuracy.

In the case of Monte Carlo sampling, the parameter space is sampled by a predetermined number of tuples 303 that are determined at random and independently of one another.

In the case of Latin Hypercube sampling, the parameter space is sampled in accordance with a regular grid that extends over the parameter space by a predetermined number of randomly and independently determined tuples 303 such that each tuple 303 is the only one in its hyperplane or in the 2D example illustrated in FIG. 3 is the only one in its vertical and/or horizontal position.

FIG. 4 schematically illustrates an apparatus 400 for determining a product quality Q that results from a manufacturing method in accordance with exemplary embodiments of the disclosure.

The apparatus 400 is designed in several parts.

It includes a simulation facility 402 for the simulative determination 202 of one of multiple manufacturing state variables X as a function of a scattering manufacturing state variable of the manufacturing state variables X; a detection facility 404 for the sensory detection 204 of one of the manufacturing state variables X; and a determination facility 408 for the associative determination 208 of the product quality Q as a function of the manufacturing state variables X.

Moreover, the apparatus 400 may be configured so as to perform the method 200 in accordance with exemplary embodiments of the disclosure.

As a result, the method features mentioned above may be used analogously in the device, wherein the respective advantages are also achieved.

As indicated by dashed lines in FIG. 4, the apparatus may in this sense include in particular a simulative detection facility (a “virtual sensor”) 406 for the simulative detection 206 of one manufacturing state variable X_{VSEN} that cannot be detected in a sensory manner of the manufacturing state variables X as a function of the manufacturing state variable X_{SEN} that is detected in a sensory manner of the manufacturing state variables X.

Function and advantages of the virtual sensor 406 correspond in this case to those of the method act of the simulative detection 206.

Moreover, the apparatus may include a separation facility for separating the product in dependence upon its determined product quality Q.

In other words, it is therefore possible to treat manufactured products with insufficient product quality Q differently than manufactured products with sufficient product quality Q. For example, separated products may be sent for post-processing or recycling instead of to a supply chain/logistics.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for determining a product quality that results from a manufacturing method, the method comprising:
performing a simulative determination of one of multiple manufacturing state variables as a function of a scattering manufacturing state variable of the manufacturing state variables;
conducting a sensory detection of one of the manufacturing state variables;
carrying out an associative determination of the product quality as a function of the manufacturing state variables obtained through the simulative determination and the sensory detection, wherein the manufacturing state variables are used as input variables for the associative determination, wherein the associative determination comprises performing a machine learning method, and wherein through the associative determination, a total of all determined or recorded manufacturing state variables are connected or linked to a product quality of the manufactured product based on a predictive model; and
providing the predictive model, which is configured to make a statement regarding a product quality based on the manufacturing state variables.

2. The method of claim 1, wherein the performing of the simulative determination comprises performing a system simulation of the manufacturing method.

3. The method of claim 2, further comprising:
executing a simulative detection of one manufacturing state variable that cannot be detected in a sensory manner of the manufacturing state variables as a function of the manufacturing state variable that is detected in a sensory manner of the manufacturing state variables.

4. The method of claim 3, wherein the executing of the simulative detection comprises executing an instance of the system simulation, the instance being simplified in terms of computational complexity, and/or an analytical equation.

5. The method of claim 2, wherein the system simulation is parameterized as a function of the scattering manufacturing state variable of the manufacturing state variables.

6. The method of claim 2, wherein the system simulation comprises a continuous simulation, a one-dimensional simulation, an analytical equation, or a combination thereof.

7. The method of claim 6, wherein the continuous simulation comprises a finite element method, a computational fluid dynamics method, a multi-body simulation, or a combination thereof.

8. The method of claim 1, wherein the simulative determination comprises sampling a value range of the scattering manufacturing state variables of the manufacturing state variables.

9. The method of claim 8, wherein sampling comprises performing a statistical experimental design method.

10. The method of claim 9, wherein the statistical experimental design method comprises Monte Carlo sampling and/or Latin Hypercube sampling.

11. (canceled)

12. The method of claim 1, wherein the machine learning method comprises a decision tree, an artificial neural network, or a combination thereof.

13. An apparatus for determining a product quality that results from a manufacturing method, the method comprising:
a simulation facility for a simulative determination of one of multiple manufacturing state variables as a function of a scattering manufacturing state variable of the manufacturing state variables;
a detection facility for a sensory detection of one of the manufacturing state variables ; and
a determination facility for an associative determination of the product qualityas a function of the manufacturing state variables obtained through the simulative determination and the sensory detection, wherein the manufacturing state variables are used as input variables for the associative determination, wherein the associative determination is configured to be performed via machine learning, and wherein, through the associative determination, a total of all determined or recorded manufacturing state variables are configured to be connected or linked to a product quality of the manufactured product based on a predictive model,
wherein the apparatus is configured to create the predictive model, which is configured to make a statement regarding a product quality based on the manufacturing state variables.

14. The apparatus of claim 13, wherein the apparatus is further configured to:
execute a simulative detection of one manufacturing state variable that cannot be detected in a sensory manner of the manufacturing state variables as a function of the manufacturing state variable that is detected in a sensory manner of the manufacturing state variables.
